(19) United States
(12) Patent Application Publication
(10) Pub. No.: US 2009/0322794 A1
(43) Pub. Date: Dec. 31, 2009

(54) DISPLAY WITH IMPROVED UNIFORMITY

(75) Inventors: Anthony Cyril Lowe, Braishfield (GB); Paul Andrew Bayley, Cambridge (GB)

Correspondence Address: BARNES & THORNBURG LLP, P.O. BOX 2786, CHICAGO, IL, 60690-2786, US

(73) Assignee: SCREEN TECHNOLOGY LIMITED, Cambridge (GB)

(21) Appl. No.: 12/095,833

(22) PCT Filed: Nov. 8, 2006
(86) PCT No.: PCT/GB2006/004167

§ 371 Date: Oct. 28, 2008

(30) Foreign Application Priority Data
Dec. 1, 2005 (GB) 0524545.1

(51) Int. Cl. G09G 5/10; G09G 3/36

(52) U.S. Cl. 345/690; 345/89; 345/88

(57) ABSTRACT

An image display is disclosed comprising an image display device with a light emitting surface having an array of picture elements; a light guide formed from a plurality of light transmission guides with the input to each light transmission guide being provided by a sub-array of a plurality of picture elements from the light emitting surface of the image display device and luminance correction means to assign a colour component value and a dither fraction value to each sub-array of a plurality of picture elements on the light emitting surface of the image display device. Assigning a colour component value (120) and a dither fraction value (122) to each sub-array of picture elements on the image display device can correct for differences related to individual image display device or light guide non-uniformity at the individual pixel level or for differences between image displays when used with multiple image display devices.

This invention relates to displays.

The technology behind flat-panel displays, such as liquid crystal displays (LCD) or plasma displays, has advanced to the stage where a single display can economically be manufactured to about the screen size of a large size domestic television set. To increase the display size of a single-unit display beyond this level introduces greater costs, lower manufacturing yields and other significant technical problems.

To provide larger displays, therefore, a hybrid technology has been developed whereby multiple smaller rectangular displays are tessellated to form the required overall size. For example, a 3×3 tessellated array of 15-inch diagonal displays, with appropriate addressing electronics to route pixel information to the appropriate sub-display, would provide a 45-inch diagonal display.

A drawback of this type of arrangement is that the active area of an individual display, that is to say, the area of the front face of the display on which pixel information is displayed, does not extend to the very edge of the physical area of the display. The technologies used, whether plasma, liquid crystal or other, require a small border around the edge of the active display area to provide interconnections to the individual pixel or picture elements and to seal the rear to the front substrate. This border can be as small as a few millimetres, but still causes unsightly dark bands across a tessellated display.

Various solutions have been proposed to this problem, most of which rely on bulk optic or fibre optic light transmission guides to translate or expand the image generated at the active area of the individual sub-displays. In the case where the image is expanded, the device will be termed an image expander or light guide.

For example, U.S. Pat. No. 4,139,261 (Hilsum) uses a wedge structure light guide formed of a bundle of optical fibres to expand the image generated by a panel display so that by abutting the expanded images, the gap between two adjacent panels, formed of the two panels' border regions, is not visible. The input end of each fibre is the same size or less than a picture element. The optical fibres are aligned, at their input ends, with individual picture elements of the panel display, so that the pixel structure of the display is translated to the output plane of the light guide. Other light guides formed in this way may translate the image to provide a border-less abutment between a pair of adjacent panels. Various types of light transmission guide may be used, such as rigid or semi-rigid light transmission guides. It has been proposed that the guides could be fabricated from polymer materials, for ease of manufacture.

A possible problem associated with the formation of a larger display from a matrix of smaller ones is that various properties of the system may cause non-uniformity of the image at the output plane of the light guide. For example, there may be a variation in the luminance between individual display panels, which could be LCD, plasma or other types of display. There may also be variance in the luminance between different portions of a display panel. Various means of correcting such non-uniformities are known in the art. For example, Someya (U.S. Pat. No. 5,396,257) describes a system using a computer-generated look-up table, which can be used to modify the signals sent to the display panel. The use of neutral-density filters placed in proximity to the display panel is described in WO 97/36281 A (Rainbow Displays Inc.).

A display based on an array of light guides has been proposed by Lowe et al in (WO 03/067563), in which a light guide is made of an array of moulded light transmission guides, each light transmission guide forming one output pixel on the output face of the light guide.

According to a first aspect of the present invention there is provided an image display comprising an image display device with a light emitting surface such as a flat panel display, the light emitting surface having an array of picture elements;
a light guide formed from a plurality of light transmission guides with the input to each light transmission guide being provided by a sub-array of a plurality of picture elements from the light emitting surface of the image display device and
luminance correction means to assign a colour component value and a dither fraction value to each sub-array of a plurality of picture elements on the light emitting surface of the image display device.

Assigning a colour component value and a dither fraction value to each sub-array of picture elements on the image display device which provide the inputs to light transmission guides of the light guide can correct for differences which could be related to individual image display device or light guide non-uniformity at the individual pixel level or to correct for macroscopic differences between image displays when used with multiple image display devices.

As a sub-array of a plurality of picture elements from the image display device is provided as the input to a single light transmission guide which has a single viewed output pixel, such displays have output pixels which are larger in size than the picture elements of the image display device. Such displays are particularly suitable for use in, for example, public spaces or other large areas where the viewing distance i.e. the distance between the viewer and the display is of the order of or greater than a few metres. Such displays are also particularly suitable for use with an array of multiple image display devices to form a larger display.

The sub-array of picture elements may be an array of m×n picture elements on the image display device, where m and n are any number, which may or may not be the same.

The colour component value assigned to a sub-array may indicate a grey level at which the plurality of picture elements in the sub-array are driven to create an output luminance value close to an ideal value and the dither fraction value may indicate at least one of the number of picture elements in the sub-array to be driven at a grey level different from the value assigned by the colour component and the grey level difference between the dithered and non-dithered picture elements of a sub-array to achieve an output luminance value closer to an ideal value.

The grey level difference between the colour component value and the dither fraction value may be one grey level and the dither fraction value may be indicative of the number of picture elements in the sub-array to be driven at the different grey level. Alternatively or additionally, the grey level difference between the colour component value and the dither fraction value may be greater than one grey level and the dither fraction value may be indicative of the grey level difference.

Each picture element may be a picture element group, for example comprising a red picture element, a green picture element and a blue picture element or alternatively may be a single picture element for example for a monochrome image display.

If a picture element is picture element group, the luminance correction means may be applied independently to each element of the group.

A further possible problem with such image displays is that the image display device is likely to have a different coefficient of thermal expansion from the light guide. Thus if the image display device expands at a different rate from the light guide when heated, for example during operation or when exposed to direct sunlight, the dithered picture elements in the sub-arrays on the image display device may become misaligned with the input of their respective light transmission guides, increasing non-uniformity of the image at the output of the light guide. Furthermore, during relative expansion or contraction, the image display device and light guide will be moved in different relative directions depending upon which region of the image display they are provided.

In order to reduce the effect of this problem, the position or grey level difference of dithered picture elements in the sub-array may be controlled dependent upon the position of the sub-array in the image display device. The dithered picture elements in a sub-array are preferably selected such that they are not the first and may be substantially the last to become registered to an adjacent light transmission guide during relative movement of the image display device and light guide during expansion or contraction.

According to a further aspect of the present invention there is provided a method of controlling an image display comprising:
an image display device with a light emitting surface, the light emitting surface having an array of picture elements and
a light guide formed from a plurality of light transmission guides with the input to each light transmission guide being provided by a sub-array of a plurality of picture elements from the light emitting surface of the image display device,
the method comprising assigning a colour component value and a dither fraction value to each sub-array of a plurality of picture elements on the light emitting surface of the image display device.

Various other respective aspects and features of the invention are defined in the appended claims. Features from the dependent claims may be combined with features of the independent claims as appropriate and not merely as explicitly set out in the claims.

Embodiments of the invention will now be described, by way of example only, with reference to the accompanying drawings in which:

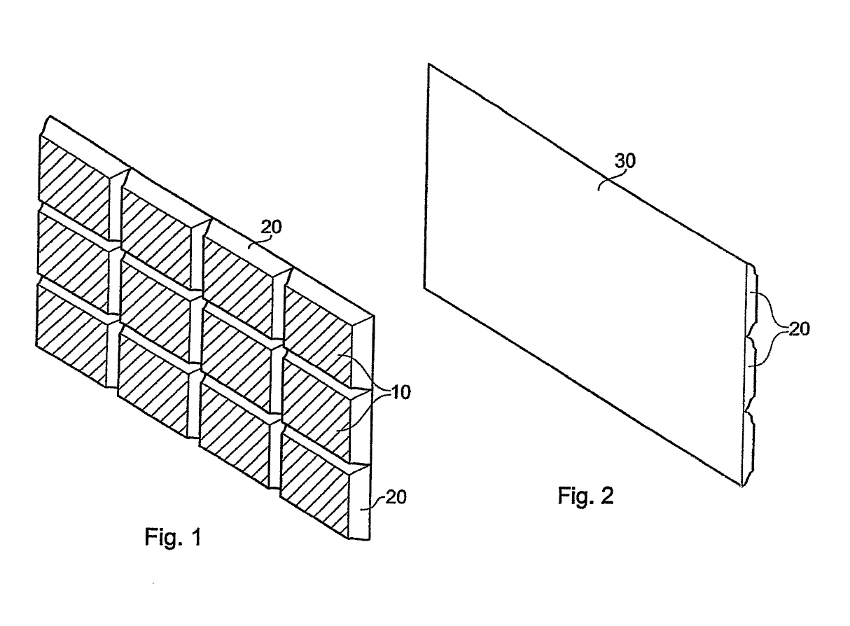

FIG. 1 is a schematic isometric rear view of a tiled array of display panels;

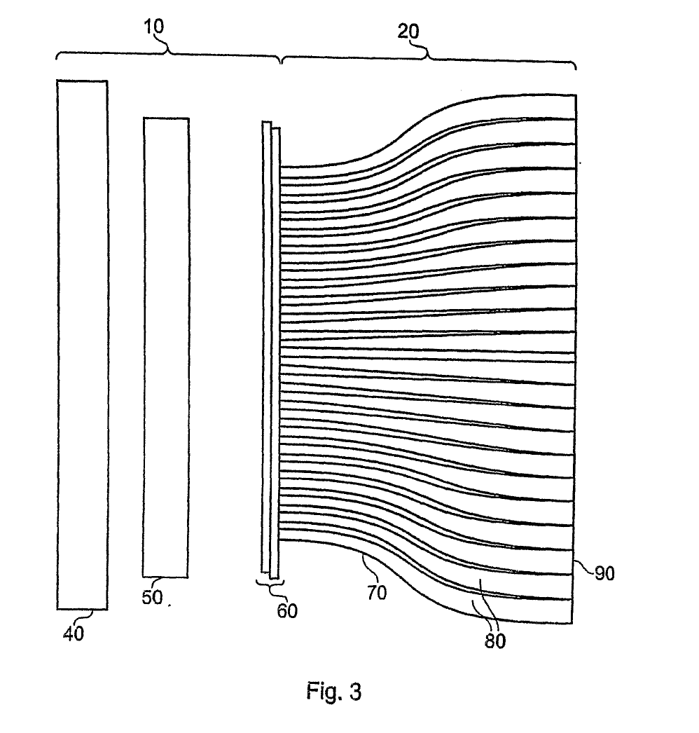

FIG. 2 is a schematic isometric front view of the array of FIG. 1;

FIG. 3 is a schematic side view of a display comprising a light source, a homogeniser, a display panel and an image guide;

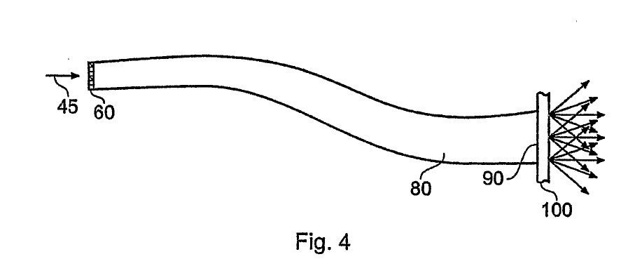

FIG. 4 is a schematic side view of a light transmission guide,

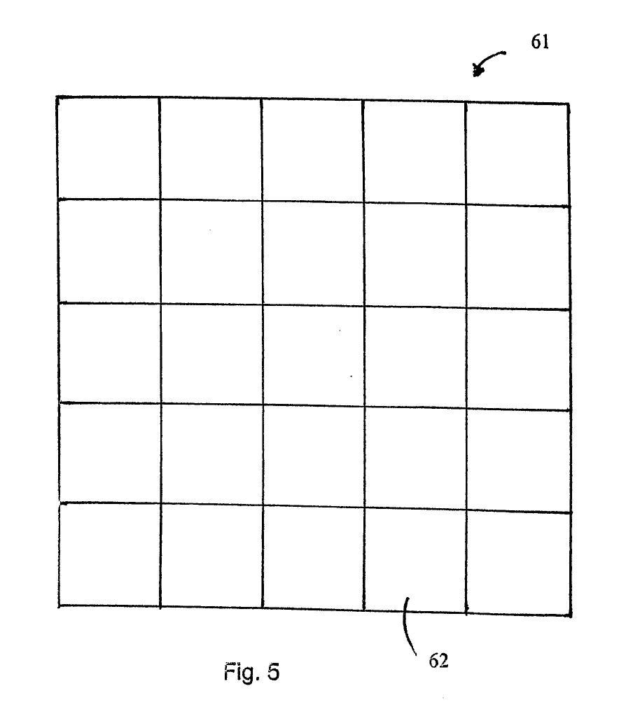

FIG. 5 is a schematic view of a sub-array of picture element groups which form the input to a single light transmission guide;

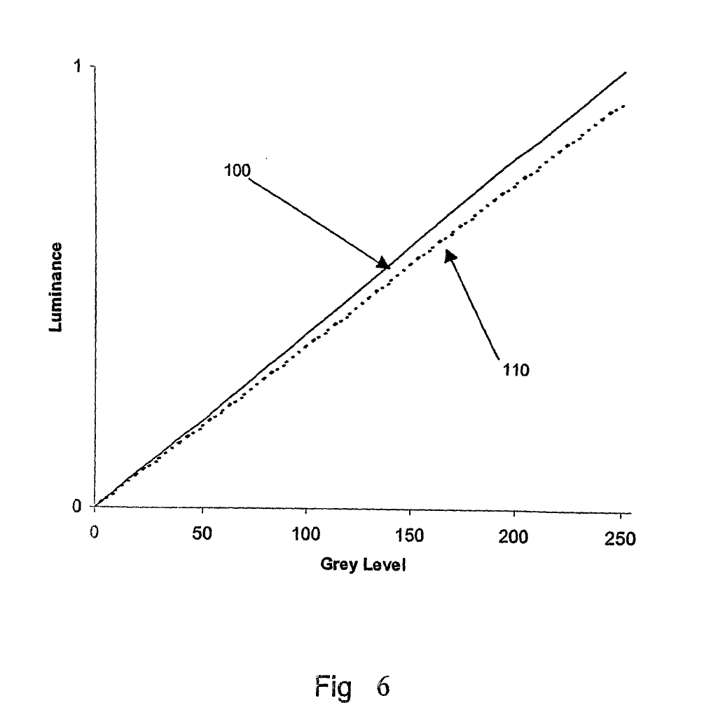

FIG. 6 shows an example of ideal and measured luminance vs. grey level for a particular image display;

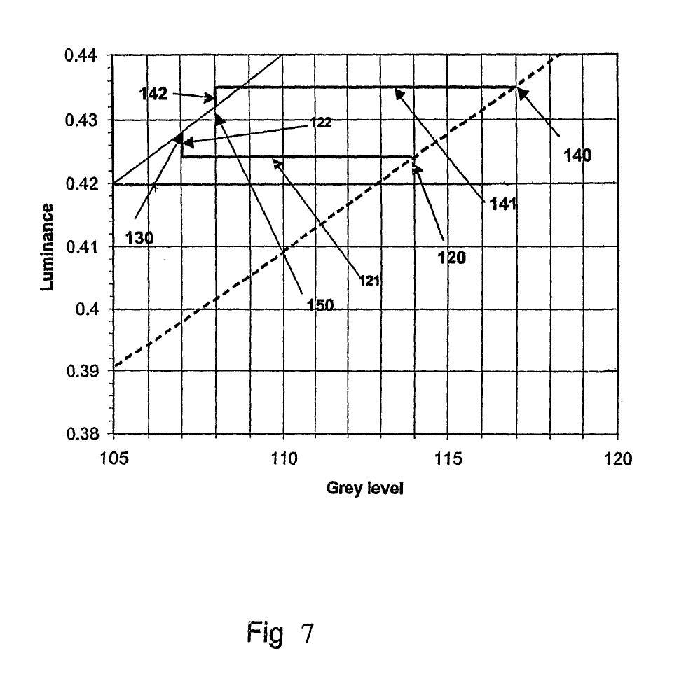

FIG. 7 shows an enlargement of a portion of FIG. 6;

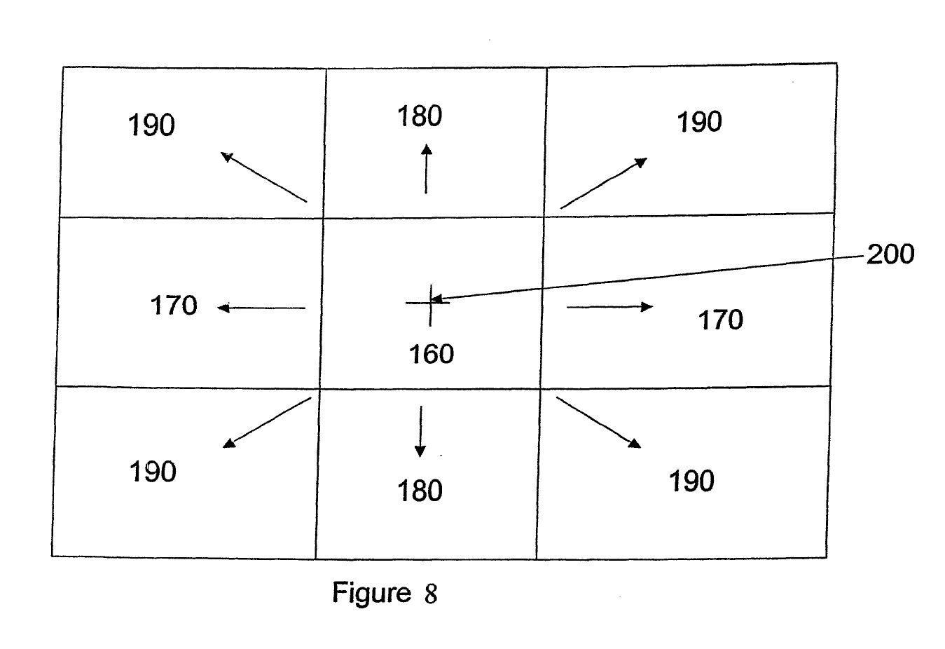

FIG. 8 schematically illustrates differential thermal expansion between a light emitting surface of a display panel and a light guide and

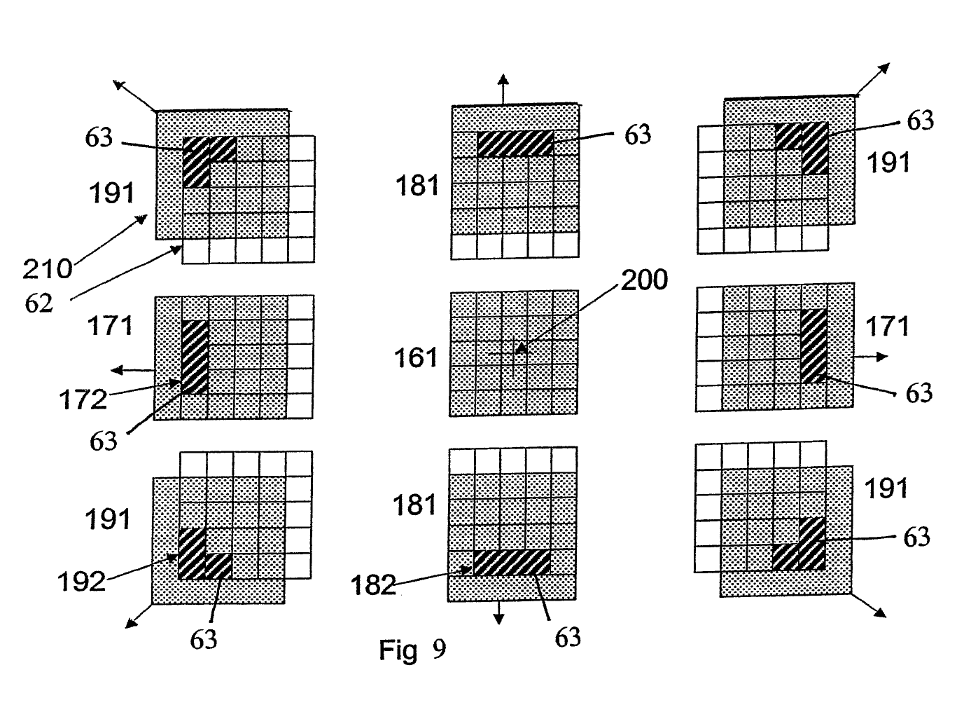

FIG. 9 schematically shows positioning of dithered picture element groups within a sub-array to account for differential thermal expansion.

FIG. 1 is a schematic isometric rear view of a tiled array of display panels.

The array comprises four display panels in a horizontal direction and three display panels in a vertical direction. Each display panel comprises a light emitting surface 10 and a light guide 20.

The light emitting surfaces 10 are each arranged as a plurality of pixels or picture elements. In practice, they might include, for example, a back light arrangement, focusing, collimating and/or homogenising optics and a liquid crystal panel or the like, but much of this has been omitted for clarity of the diagram.

The light emitting panels each display portions of an overall image to be displayed. The portions represent adjacent tiles in a tessellated arrangement. However, because of the need to run electrical connections and physical support around the edge of the light emitting surfaces 10, they cannot be directly abutted without leaving a dark band or “black matrix” in between. So, the light guides 20 are used to increase the size of the image from each light emitting surface 10 so that the output surfaces of the light guides 20 can be abutted to form a continuous viewing plane.

This arrangement is shown in FIG. 2 which is a schematic isometric front view of the array of FIG. 1. Here, the output surfaces of the light guides 20 abut so as to form a continuous viewing surface 30.

FIG. 3 is a schematic side view of a display comprising a collimated light source 40, optical control films 50, a liquid crystal panel 60 and a light guide 70.

The collimated light source 40 and the optical control films 50 are shown in highly schematic form but, in themselves, form part of the state of the art. The particular optical control films 50 which are schematically illustrated include prismatic and polarisation recycling films (such as those manufactured respectively under the names BEF and DBEF by the 3M Company) to provide the back light required by the liquid crystal panel 60.

The liquid crystal panel 60 may be of a type which uses a white or other visible colour back light and provides liquid crystal picture elements to modulate that back light for that display. Alternatively, the liquid crystal panel 60 may be a photo luminescent liquid crystal display panel which employs an ultra-violet back light and modulates the ultra-violet light onto an array of phosphors to generate visible light for display. Of course, many other types of light emitting surface 10 may be used such as an organic light emitting diode array.

The image guide 70 comprises an array of light transmission guides 80, each of which carries light from a particular area on the liquid crystal panel 60 to a corresponding particular area on an output surface 90. In doing so, the light transmission guides are arranged to diverge so that the area covered on the output surface 90 is physically larger than the image display area on the liquid crystal panel 60. This, as described above, allows an array of displays as shown in FIG. 3 to be abutted without an unsightly black matrix between tiles at the viewing plane.

FIG. 4 is a schematic side view of a light transmission guide 80. The light transmission guide 80 as shown is similar in function to an optical fibre, having an internal core surrounded by cladding material (even air), the core and the cladding having appropriate refractive indices so as to cause total internal reflection within the optical fibre.

Alternatively, the guide 80 may be in the form of a hollow tube having a reflecting inner surface, so that light within the guide undergoes multiple specular reflections as it passes along the guide. In another alternative, the guide could be formed of a solid transparent material such as glass or a plastics material but have a reflecting outer surface or coating, for example a coating of a metal such as silver or aluminium. Again, this would lead to multiple internal specular reflections as light passes along the guide.

So, in operation, illumination from the back light 40 and the optical control films 50 passes through picture elements of the display panel 60 before entering the guide 80. The light passes along the guide and towards its output 90. In the drawing, this is shown as propagation from the left to the right of the drawing. The output end of the guide forms a viewing surface and may be covered by a diffuser panel or some other panel designed to modify the angular distribution of the intensity of light reaching the viewer 100.

In FIG. 5 there is shown a sub-array 61 of 5×5 picture element groups 62 which form the input to a single light transmission guide 80 (and therefore represent a single “output” picture element for viewing at the viewing surface 90). Each picture element group 62 comprises a red picture element R, a green picture element G and a blue picture element B (not shown). So, in the entire sub-array 61 forming the input to one light transmission guide 80, there are 75 picture elements, being 25 each of the red, green and blue picture elements. Alternatively, each picture element group 62 may be a single element for example for a monochrome image display.

Although the sub-array 61 shown in FIG. 5 is comprised of 5×5 picture elements or picture element groups 62, the sub-array could comprise any number of picture elements or picture element groups arranged in any desired pattern. A rectangular sub-array 61 of m×n picture elements or picture element groups where m and n are any whole number may be used for example.

Luminance correction for an image display, such as the one shown in FIG. 2 for example, will now be described. The luminance correction may be performed by any suitable means such as control electronics, a microprocessor or a computer. In a first embodiment of the invention, luminance correction is applied at the level of an individual output 90 formed from a sub-array 61 as shown in FIG. 5 for example. The light emitting surface 10 is driven sequentially from the lowest to the highest grey level for each colour (red, green and blue). In a typical LCD panel, the drivers are capable of a range of 8 bits (or 256 increments or grey levels) between the lowest and the highest luminance value. Such a display panel will be used as an example of the light emitting surface 10 for the following description, but the invention is not restricted to 8 bit-per-colour display panels and is applicable to any light emitting surface 10 capable of displaying more than two grey levels. An image of the output face of the light guide 70 is obtained at each grey level for each colour and the luminance data for the output of each light transmission guide 80, hereinafter termed each output pixel are stored on a computer system. Alternatively, if the uniformity of the luminance vs. grey level behaviour of the display panel allows it, data can be recorded at intervals greater than a single grey level, with the intermediate levels being calculated by interpolation. A suitable instrument for recording the data would be an imaging photometer such as an Instrument Systems LumiCam 1300 Colour Imaging Photometer or alternatively any digital camera of suitable resolution, which has been photometrically calibrated.

Referring now to FIG. 6, the solid line 100 defines an ideal luminance vs. grey level curve for a particular image display. The dotted line 110 represents a measured luminance vs. grey level curve.

For the avoidance of doubt, an output pixel is defined as a pixel viewed on the output surface 90 of the light guide 70. There is one output pixel per light transmission guide 80. In general, a sub-array of m×n picture elements or picture element groups 62 is used as the input per output pixel.

The recorded data are used to create a look-up table. Each table has 256 elements and each element has two values. The first value is a “colour component” value in the range 0 to 255. The second value is a “dither fraction”.

Referring now to FIG. 7, which shows an enlargement of a portion of FIG. 6, these values are assigned as follows:

In one embodiment of the invention, the colour component value is the grey level to which the sub-array of m×n picture element groups 62 must be driven 120 to bring the displayed luminance of the output pixel as close as possible to the ideal value 130 without exceeding it. In the example shown, to achieve the required ideal luminance of grey level 107, the picture element groups 62 must be driven at grey level 114 to bring them as close as possible to, but not greater than, the required level, represented by the horizontal line 121. The dither fraction represents the number of picture element groups 62 within the m×n sub-array which must be driven to the next higher grey level to bring the displayed luminance as close as required to the required ideal luminance value and is represented by the vertical line 122. The fact that different picture element groups 62 are driven at different grey levels has no deleterious effect on the display appearance. This is because light from the entire m×n sub-array of picture element groups 62 is mixed, or homogenised, on propagation through a light transmission guide 80. The viewer sees the integrated input luminance, not the individual picture element groups 62.

In a preferred embodiment of a tiled display, an array of 5×5 picture element groups 62 is as shown in FIG. 5 is used for each output pixel. In this example the dither fraction can have any value between 0 and 25 as any number of the input pixels or picture element groups 62 within the 5×5 sub-array may be driven at the next higher grey level. Thus the colour component can be described as a coarse correction means and the dither fraction as a fine correction means. In this example, the dither fraction enables correction increments of 0.04 or 1/25 of a colour component increment to be made.

The person skilled in the art will realise that the general principle described here can be used with a sub-array of any size greater than 1×1 and that the sub-array is not limited to being square in shape.

In another embodiment of the invention, referring again to FIG. 7, the colour component value 140 can be chosen to bring the luminance to a value higher 141 than the required value 150 and the dither fraction 142 then represents the number of picture element groups 62 which must then be driven at the next lower level to achieve the required value.

In yet another embodiment of the invention, the dither fraction can be assigned to grey levels having a difference greater than 1 from the value assigned to the colour component. For example, rather than drive five picture element groups 62 at a grey level one higher or lower than the colour component value, a single picture element group 62 can be driven at a grey level five higher or lower than the colour component value or one picture element group 62 can be driven at a grey level three higher or lower than the colour component value and another two higher or lower. This has some advantages in reducing the number of picture element groups 62 requiring to be dithered, as will be explained below.

In general, because modern display panels are rather uniform in their properties, the colour component value will be the same for adjacent picture element groups 62 within a light emitting surface 10 formed by a single display panel or within an array of a plurality of display panels and all the pixel-to-pixel luminance non-uniformity can be corrected by means of the dither fraction. This point is of relevance to the following embodiment of the invention. However, it is envisaged in the present invention that if necessary luminance non-uniformity may also be corrected using both the colour component value and the dither value.

In general, the display panel with light emitting surface 10 and the light guide 20 will have different coefficients of thermal expansion, so the display panel and the light guide 20 will be in perfect registration at only on temperature. For example, if the display panel is made of glass and the light guide 20 is made of an array of moulded polymeric light transmission guides 80, then the light guide 20 will expand or contract to a greater extent than the display panel when the temperature of the display respectively increases or decreases. If the dithered area of the m×n sub-array of picture element groups 62 expands or contracts into the area of an adjacent light transmission guide 80, then the calibration of the display will be degraded. To avoid such degradation, an embodiment of this invention is arranged such that the dithered area can be made of such a size and/or can be so positioned within the picture element groups 62 sub-array that the amount of misregistration which can occur before the dithered area overlaps on to an adjacent light transmission guide 80 can be maximised. This will increase the temperature range over which the display can operate optimally, without loss of luminance uniformity.

Referring now to FIG. 8, the light guide 20 is located with respect to the light emitting surface 10 of the display panel such that differential expansion between the two takes place from a neutral point 200. By way of example, this is shown at the geometrical centre of the display panel, but other positions for the neutral point are possible and are implicitly included. The light emitting surface of the display panel can be divided into a number of different regions. In the example shown here, there is a central region 160, close to the neutral point 200, in which the differential expansion is sufficiently small that no special action is necessary. There are four regions in which the differential expansion is substantially horizontal 170 or vertical 180 and four regions 190 in which the differential expansion is substantially in a diagonal direction. Differential expansion occurs substantially in the direction shown by the arrows. Depending on the extent of differential expansion between the light emitting surface 10 of the display panel and the light guide 20, more or fewer regions could be used, but those shown in FIG. 8 serve as an example.

In a preferred embodiment of the invention, the geometrical arrangement and position of the dithered picture element groups 62 within the sub-array 61 is selected according to the direction of differential expansion in each region. However, if desired just one of the geometrical arrangement and position of the dithered picture elements 62 may be varied according to the direction of differential expansion in that region. By way of example, it is assumed that the light emitting surface 10 of the display panel and the light guide 20 are in perfect registration at room temperature, say 20 degrees Celsius. In operation, because of heat generated within the display, the display will operate at a temperature above room temperature, so the light guide 20 will expand to a greater extent than the light emitting surface 10 of the display panel. Referring now to FIG. 9, the differential expansion is qualitatively shown in each of the nine regions of FIG. 8. The differential expansion is insignificant 161 or is substantially in a horizontal 171, vertical 181 or diagonal 191 direction. The input apertures 210 of the light transmission guides 80 expand away from the neutral point 200 to a greater extent than the associated sub-arrays 61 of picture element groups 62 on the light emitting surface 10 of the display panel. The preferred positions and patterns of the dithered picture element groups 62 are shown for the horizontal 172 vertical 182 and diagonal 192 regions respectively by diagonal shaded picture element groups 63 for the case where three dithered picture element groups are required.

A person skilled in the art will realise that other patterns of dithered picture element groups 62 are possible and that number of picture element groups 62 required to be dithered will depend on the extent of expansion mismatch between the light emitting surface 10 of the display panel and the light guide 20. The fewer the number of dithered picture element groups 62 used, the greater is the amount of mismatch which can be accommodated. The number of dithered picture element groups 62 will also depend on the extent of luminance non-uniformity within and between display panel/light guide 20 combinations. The greater the degree of non-uniformity, the greater will be the number of dithered light element groups 62 or the greater the degree of luminance difference between the colour component and the dithered level required.

In another embodiment of the invention, temperature probes are positioned appropriately in the system to monitor the temperature close to the light emitting surface 10/light guide 20 interface. Luminance measurements at each grey level or at a selection of grey levels for each colour are measured, as already described, at a number of different temperatures. During operation, the temperature probes send temperature data to the control electronics, which determine or look-up the appropriate luminance correction data and apply the appropriate corrections. In this embodiment of the invention, temperature variation of the characteristics of the display panel are accounted for in addition to the non-uniformities already described by appropriate selection of the position or grey level difference of the dithered light element groups 62 depending upon the position of the sub-array in the image display device.

In yet another embodiment of the invention, in addition to providing a precise correction means for luminance and colour non-uniformity, the colour temperature of a display may be modified to meet precise user requirements. This embodiment would in many cases be preferable to the alternative, which would be to modify the emission characteristics of the backlight if an LCD panel was used as the display panel. In cases where emissive display panels were used, this embodiment would be the only possible means, other than changing the composition of the display panels, for adjusting the colour temperature of the display.

A computer, microprocessor or suitable control electronics may be used to provide the luminance correction data (colour component value and dither fraction). These values may be calculated or looked-up in a suitable look-up table. The positioning and/or grey level difference of the dithered picture elements 62 within a sub-array 61 may depend upon the position of the sub-array in the image display. The luminance correction means may be provided with an input indicating whether the display will operate predominantly above or below the temperature of alignment of the image display device and light guide. This information may be used to determine whether the image display device and light guide will predominantly move relative to each other in one direction or the other to adjust the characteristics of the dither fraction accordingly.

One or more temperature sensors may be provided in the display and the positioning and/or grey level difference of the dithered picture elements 62 may be dependent upon the one or more temperature measurements. The positioning and/or grey level difference of the dithered picture elements 62 at a particular temperature measured by the one or more sensors may be based on prior luminance and/or relative thermal expansion/contraction measurements made to calibrate the image display.

Many variations may be made to the embodiments described above whilst still falling within the scope of the invention. For example the sub-array 61 may be any size, shape or number of a plurality of picture element groups 62. The picture element groups 62 may each comprise a red, green and blue picture element or may each be a single element for example for a monochrome display or may be any other arrangement of one or more picture elements.

1. An image display comprising:
an image display device with a light emitting surface, the light emitting surface having an array of picture elements;
a light guide formed from a plurality of light transmission guides with the input to each light transmission guide being provided by a sub-array of a plurality of picture elements from the light emitting surface of the image display device and
luminance correction means to assign a colour component value and a dither fraction value to each sub-array of a plurality of picture elements on the light emitting surface of the image display device.

2. An image display according to claim 1, wherein the sub-array of a plurality of picture elements is an array of m×n picture elements on the image display device and where m and n may be any whole number greater than zero which may or may not be the same and at least one of m and n is greater than one.

3. An image display according to claim 1, wherein the colour component value assigned to a sub-array of picture elements indicates a grey level at which the plurality of picture elements in the sub-array are to be driven to create an output luminance close to an ideal value and the dither fraction indicates at least one of the number of picture elements in the sub-array to be driven at a grey level different from the value assigned by the colour component and the grey level difference between the dithered and non-dithered picture elements of a sub-array.

4. An image display according to claim 3, wherein the grey level difference between the colour component value and the dither fraction value is one grey level and the dither fraction value is indicative of the number of picture elements in the sub-array to be driven at the different grey level.

5. An image display according to claim 3, wherein the grey level difference between the colour component value and the dither fraction value is greater than one grey level and the dither fraction value is indicative of the grey level difference.

6. An image display according to claim 1, wherein each picture element is a picture element group.

7. An image display according to claim 6, wherein each picture element group comprises a red picture element, a green picture element and a blue picture element.

8. An image display according to claim 6, wherein the luminance correction means is applied independently to each picture element of the group.

9. An image according to claim 1, wherein the image display comprises a plurality of image devices and light guides.

10. An image display according to claim 1, wherein the position or grey level difference of dithered picture elements in the sub-array is selected dependent upon the position of the sub-array in the image display.

11. An image display according to claim 10, wherein the dithered picture elements of a sub-array are selected such that they are not the first to become registered to an adjacent light transmission guide during relative movement of the image display device and light guide during thermal expansion or contraction.

12. An image display device according to claim 11, wherein the dithered picture elements of a sub-array are selected such that they are substantially the last to become registered to an adjacent light transmission guide during relative movement of the image display device and light guide during thermal expansion or contraction.

13. An image display according to claim 10, wherein the luminance correction means is arranged to receive an input indicating whether the display will operate predominantly above or below the temperature of registration of the image display device and light guide and the position or grey level difference of the dithered picture elements is dependent upon the input indicating whether the display will operate above or below the temperature of registration.

14. An image display according to claim 10, wherein the luminance correction means is arranged to receive an input indicative of the operating temperature of the display and the position or grey level difference of the dithered picture elements is dependent upon the input indicative of the operating temperature.

15. An image display according to claim 1, wherein luminance correction data is looked up in a look-up table.

16. An image display according to claim 1, wherein luminance correction data is calculated by the luminance correction means.

17. An image display according to claim 1, wherein the luminance correction means is arranged to adjust the colour temperature of the display.

18. A method of controlling an image display comprising:
an image display device with a light emitting surface, the light emitting surface having an array of picture elements and
a light guide formed from a plurality of light transmission guides with the input to each light transmission guide being provided by a sub-array of a plurality of picture elements from the light emitting surface of the image display device,
the method comprising assigning a colour component value and a dither fraction value to each sub-array of a plurality of picture elements on the light emitting surface of the image display device.

19. A method according to claim 18, wherein the colour component value assigned to a sub-array of picture elements indicates a grey level at which the plurality of picture elements in the sub-array are to be driven to create an output luminance close to an ideal value and the dither fraction value indicates at least one of the number of picture elements in the sub-array to be driven at a grey level different from the value assigned by the colour component and the grey level difference between the dithered and non-dithered picture elements of a sub-array.

20. A method according to claim 18, wherein the position or grey level difference of dithered picture elements in the sub-array is selected dependent upon the position of the sub-array in the image display.

21. (canceled)

22. (canceled)
